(19) United States
(12) Patent Application Publication
(10) Pub. No.: US 2005/0236448 A1
(43) Pub. Date: Oct. 27, 2005

(54) Detachable tote for crutches

(76) Inventor: Dixie Reader, Pataskala, OH (US)

Correspondence Address: CALFEE, HALTER & GRISWOLD, LLP, 1110 FIFTH THIRD CENTER, 21 EAST STATE STREET, COLUMBUS, OH, 43215-4243, US

(21) Appl. No.: 10/829,569

(22) Filed: Apr. 22, 2004

(51) Int. Cl. A45B 3/00; A45B 5/00; B60R 7/00; B60R 9/00

(52) U.S. Cl. 224/407

(57) ABSTRACT

A removable storage device for use with a crutch; the device includes a flexible body in the form of an inverted pouch having an opening at the bottom of the pouch that is adapted to receive the uppermost portion of a crutch. The pouch also includes external storage pockets on the front and back portions of the pouch and a handle attached to the top portion of the pouch for carrying the storage device when it is not positioned on a crutch. The storage device also includes means for closing the opening at the bottom of the pouch.

### STATEMENT REGARDING FEDERALLY FUNDED RESEARCH

This invention was not made by an agency of the United States Government nor under contract with an agency of the United States Government.

### TECHNICAL FIELD OF THE INVENTION

The present invention relates generally to devices and accessories for use by injured, handicapped, or disabled people, and specifically to a detachable tote or handbag adapted to be placed over the uppermost portion of a crutch.

### BACKGROUND OF THE INVENTION

Temporarily or permanently injured or disabled persons must often use crutches for assistance in moving from place to place. Because the use of crutches requires the almost continuous use of a person's hands and arms, a person using crutches may find it very difficult to carry anything with them. For example, using a purse or a shoulder-bag may prove to be almost impossible while crutches are being used.

A number of storage devices for attachment to crutches are disclosed in the prior art. Typically, such devices are made of wood or metal and are not easily detachable from the crutch once the device has been installed or mounted. Thus, while a person using crutches may be able to tote items in these storage devices, the devices themselves cannot effectively double as a hand-bag because they are typically intended to remain on the crutch when in use. Furthermore, if the prior art storage device is easily detachable from the crutch, it is typically an unwieldy, heavy or simply unattractive item. Thus, there is a need for a hand-bag, tote, or storage device that is lightweight, comfortable, and which may be easily removed from a crutch and used as a tote or handbag.

### SUMMARY OF THE INVENTION

These and other deficiencies of the prior art are overcome by the present invention, the exemplary embodiment of which provides a removable storage device, i.e., a tote or handbag, for use on a crutch. This invention provides adults and children with greater independence when they are transporting various articles while using crutches.

In general terms, the device includes a flexible body in the form of an inverted pouch having an opening at the bottom of the pouch that is adapted to receive the uppermost portion of a crutch. The pouch includes external storage pockets on both the front and back portions of the pouch and a handle attached to the top portion of the pouch. The tote of the present invention may be manufactured in a variety of forms and from a variety of materials. The body of the tote slips over the top of the crutch and extends to just above the crutch handle where it is secured by engaging hook and loop fasteners, or other closing means, along the bottom edge. The handle, attached to the top enclosed edge of the base fabric, serves a dual purpose; to hang up the crutch and tote when not in use or to hang up just the tote once it has been removed from the crutch.

Further advantages of the present invention will become apparent to those of ordinary skill in the art upon reading and understanding the following detailed description of the exemplary embodiments.

### BRIEF DESCRIPTION OF THE DRAWINGS

The accompanying drawings, which are incorporated into and form a part of the specification, schematically illustrate one or more exemplary embodiments of the invention and, together with the general description given above and detailed description of the exemplary embodiments given below, serve to explain the principles of the invention.

FIG. 1 is front view of the detachable tote of the present invention showing the placement of the carrying handle, the front storage pocket and the opening in the bottom of the device that is adapted to receive the uppermost portion of a crutch.

FIG. 2 is a side view of the device of FIG. 1 showing the carrying handle and the front and rear storage pockets.

FIG. 3 is a front view of the device of FIG. 1 showing the device properly situated on the uppermost portion of a crutch.

### DETAILED DESCRIPTION OF THE INVENTION

An exemplary embodiment of the present invention provides a removable tote or handbag for use with a crutch. The tote includes a flexible body having an opening in the bottom portion that is adapted to receive the uppermost portion of a crutch. The body also includes external storage pockets on the front and back portions of the body and a handle attached to the top portion of the body for carrying the tote when it is not positioned on a crutch.

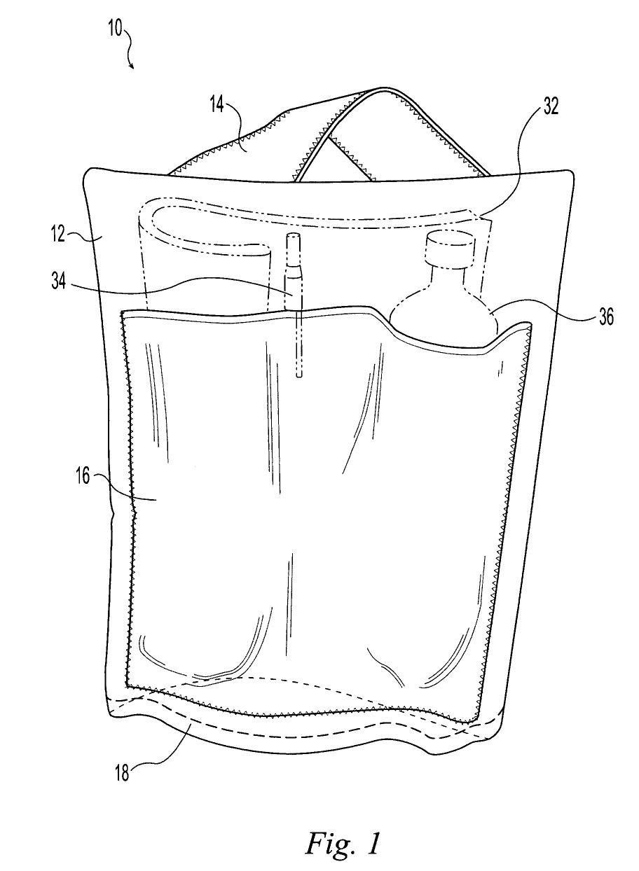

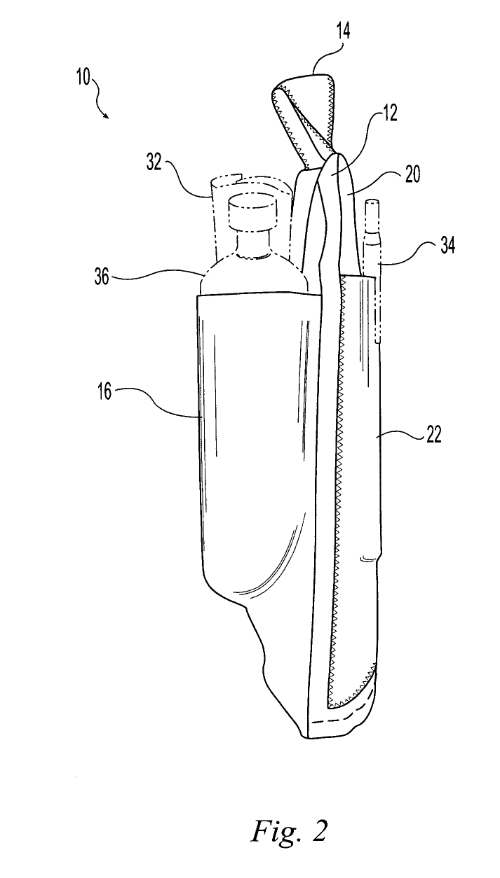

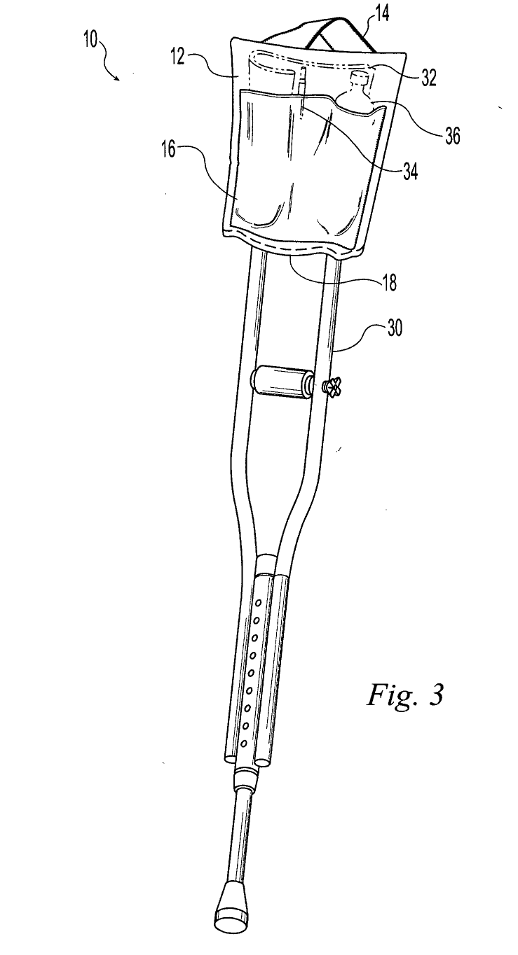

With reference now to the Figures, FIG. 1 provides a front view of detachable tote 10, showing the placement of carrying strap or handle 14, front storage pocket 16 and the opening in the bottom portion 18 of the device that is adapted to receive the uppermost portion of a crutch 30. FIG. 2 provides a side view of tote and showing carrying handle 14 and the front and rear storage pockets 16 and 22. FIG. 3 provides a front view of the tote properly situated on the uppermost portion of crutch 30.

In the exemplary embodiment shown in the Figures, the storage device, tote, or handbag of the present invention includes a body that is basically an inverted pouch, wherein the open end of the pouch is adapted to receive the portion of a crutch that typically includes the padded support. While the body may be made from a single piece of fabric or other material, in the exemplary embodiment shown in the Figures, the body includes a front panel 12 that is stitched or otherwise attached to the top and side portions of a rear panel 20. The bottom edge of the rear panel is typically not attached to the front panel, thus the two panels define a cavity or interstitial space for receiving the crutch. The bottom, open end of the pouch may be closed by utilizing a button, snap, clasp, clip, a strip of Velcro®, or combinations thereof placed on the front and/or rear panels near the open end of the pouch.

Front storage pocket 16 and rear storage pocket 22 are stitched or otherwise attached to the front and rear panels respectively, and provide storage space for a variety of items such as, for example, magazine 32, pen 34, and bottle 36 (see FIGS. 1-3). The storage pockets may include pleats, gathers, or combinations thereof for allowing the pockets to expand and contract, and they may include at least one internal divider for creating separate sections within the pockets. In an alternate embodiment, the storage pockets are made from or further include a netted material for increasing air circulation through the pockets and facilitating viewing of the contents of the pockets. The storage pockets may each include at least one additional pocket attached to the exterior of the storage pockets, and these additional pockets may extend beyond the bottom edge of the body of the tote for greater storage capacity. In another embodiment, the storage pockets further comprise flaps for closing the pockets and for securing items within the pockets. These flaps may include a zipper, snap, hook, loop fastener, button, or combinations thereof for fastening the flaps to the pockets and keeping the flaps closed. The storage pockets may also include external indicia for identifying the contents of the pockets and/or notions such as snap-clips for securing keys or other items.

In the exemplary embodiment, a handle is attached to the top, closed portion of the tote and provides a means by which the tote may be easily carried when the tote is not on a crutch. When tote 10 is in place on the crutch, handle 14 may also be used to hang the crutch on a hook or the like. The strap or handle is typically a flat, relatively thin piece of fabric or other material that does not interfere with the use of the crutch when the tote is in place on the crutch. The body, pockets, and handle of detachable tote 10 are typically made from or include a flexible material such as cotton, vinyl, nylon, plastic, or combinations thereof. Nylon strapping, strong ribbon, and soft rope may also be used for carrying handle 14.

The detachable tote of the present invention may be adapted for specific applications or users. For example one embodiment of the tote functions as a basic carry-all and utilizes sturdy, serviceable fabrics in basic colors as well as plaids, stripes and geometries patterns. Another embodiment serves as a crutch organizer for the professional and utilizes fabrics and vinyl materials comparable to materials used for briefcases and attache bags. Still another embodiment is tailored for use by children and is designed to emulate an animate object through the use of both appropriate fabrics and unique artistic details. Yet another embodiment is intended for use by athletes and utilizes fabrics and notions, such as snap-clips for securing keys, which reflect current sportswear trends and that may include licensed logos of sport leagues and universities. A final embodiment is intended for use by women for formal occasions and is made from decorative or evening wear fabric or materials.

While the above description contains much specificity, this should not be construed as a limitation on the scope of the invention, but rather as an exemplification of certain preferred or exemplary embodiments. Numerous other variations of the present invention are possible, and it is not intended herein to mention all of the possible equivalent forms or ramifications of this invention. Various changes may be made to the present invention without departing from the scope or spirit of the invention

1. A removable storage device for use with a crutch, the device comprising:
(a) a body, wherein the body further comprises an inverted pouch, and wherein the pouch further comprises an opening at the bottom of the pouch adapted to receive the uppermost portion of a crutch;
(b) at least one storage pocket on the front of the pouch; and
(c) a handle attached to the top portion of the pouch for carrying the storage device.

2. The device of claim 1, further comprising a means for closing the opening at the bottom of the pouch, and wherein the means for closing further comprises a button, snap, clasp, clip, a strip of Velcro®, or combinations thereof.

3. The device of claim 1, further comprising at least one storage pocket attached to the rear of the pouch.

4. The device of claim 3, wherein the body, pockets, and handle further comprise a flexible material, and wherein the flexible material is cotton, vinyl, nylon, plastic, or combinations thereof.

5. The device of claim 3, wherein the storage pockets further comprise pleats, gathers, or combinations thereof for allowing the pockets to expand and contract.

6. The device of claim 3, wherein the storage pockets further comprise netted material for increasing air circulation through the pockets and facilitating viewing of the contents of the pockets.

7. The device of claim 3, wherein the storage pockets further comprise flaps for closing the pockets.

8. The device of claim 7, wherein the flaps further comprise at least one means for fastening the flaps to the pockets, and wherein the fastening means further comprises a zipper, snap, hook, loop fastener, button, or combinations thereof.

9. The device of claim 3, wherein the storage pockets further comprise at least one additional pocket attached to the exterior of the storage pockets, and wherein the additional pockets extend beyond the bottom edge of the body.

10. The device of claim 3, wherein the storage pockets further comprise at least one of external indicia for identifying the contents of the pockets, notions for securing items to the pockets, and at least one internal divider for creating individual compartments within the pockets.

11. A removable storage device for use with a crutch, the device comprising:
(a) a body, wherein the body further comprises a front panel and a rear panel attached to the top and side edges of the front panel, and wherein the bottom edge of the rear panel is not attached to the front panel, and wherein the front panel and the rear panel define a cavity between the two panels for receiving the uppermost portion of a crutch;
(b) at least one storage pocket attached to the front panel;
(c) at least one storage pocket attached to the rear panel; and
(d) a handle attached to the top edge of the body.

12. The device of claim 11, further comprising a means for closing the bottom portion of the body, and wherein the means for closing further comprises a button, snap, clasp, clip, a strip of Velcro®, or combinations thereof.

13. The device of claim 11, wherein the body, pockets, and handle further comprise a flexible material, and wherein the flexible material is cotton, vinyl, nylon, plastic, or combinations thereof.

14. The device of claim 11, wherein the storage pockets further comprise pleats, gathers, or combinations thereof for allowing the pockets to expand and contract.

15. The device of claim 11, wherein the storage pockets further comprise netted material for increasing air circulation through the pockets and facilitating viewing of the contents of the pockets.

16. The device of claim 11, wherein the storage pockets further comprise flaps for closing the pockets.

17. The device of claim 16, wherein the flaps further comprise at least one means for fastening the flaps to the pockets, and wherein the fastening means further comprises a zipper, snap, hook, loop fastener, button, or combinations thereof.

18. The device of claim 11, wherein the storage pockets further comprise at least one additional pocket attached to the exterior of the storage pockets, and wherein the additional pockets extend beyond the bottom edge of the body.

19. The device of claim 11, wherein the storage pockets further comprise at least one of external indicia for identifying the contents of the pockets and notions for securing items to the pockets.

20. The device of claim 11, wherein the storage pockets further comprise at least one internal divider.
